(19) United States
(12) Patent Application Publication
(10) Pub. No.: US 2003/0017806 A1
(43) Pub. Date: Jan. 23, 2003

(54) Multi-layer, high density integrated wireless communication architecture

(76) Inventors: Albert Sutono, Atlanta, GA (US); Joy Laskar, Atlanta, GA (US); Kyutae Lim, Dunwoody, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/896,544

(22) Filed: Jun. 29, 2001

(51) Int. Cl. H04B 17/02; H04B 7/00

(52) U.S. Cl. 455/59; 455/136

(57) ABSTRACT

A system and method for providing a multi-layer, high density wireless communication architecture is disclosed. An example of a transceiver module is provided to better demonstrate this system and method. The transceiver module comprises a transmitting layer having a top portion and a bottom portion. A filter layer having a top portion and a bottom portion is also provided, wherein the top portion of the filter layer is adjacent to the bottom portion of the transmitting layer. A logic layer having a top portion and a bottom portion is provided, wherein the top portion is adjacent to the bottom portion of the filter layer and wherein logic is located on the bottom portion of the logic layer. A series of via structures of connected at specific locations of the transceiver module to allow for electrical connections between the transmitting layer and the filter layer, and the filter layer and the logic layer. Shield layers are also provided to prevent harmful electronic coupling between layers.

### FIELD OF THE INVENTION

The present invention generally relates to the architecture of wireless communication systems and, more particularly, to decreasing the size of wireless communication systems.

### BACKGROUND OF THE INVENTION

Advancements in technology have led to smaller electronic devices having greater functionality. One example of a field of technology where this is demonstrated is within the telecommunication field. The increase of functionality required by communication devices, such as, but not limited to, wireless communication devices, provides an architectural obstacle due to the number of discrete and bulky components required to enable such functionality.

Current increases in demand for higher data rates and broadband transmission require high performance transceivers. High frequency components are typically used to provide high data rates in communication devices. In addition, low-cost transceivers are desirable for wireless communication devices in order to prevent excessive increases in the cost of these devices. Unfortunately, there is a deficiency of economical high frequency components for low-cost transceivers.

With the decrease in size of communication devices, the size of components within the communication devices, such as transceivers, are also required to decrease in size. The current drawbacks of most commercially available transceivers are their relatively large size, heavy weight, and separately located modules. If these commercially available transceivers were to be used in communication devices where compactness is desirable, such as, cellular phones, portable wireless modems and local area network (LAN) cards, then it would not be possible to decrease their size. Therefore, transceiver size is an architectural obstacle in constructing smaller communication devices.

Components located within transceivers that contribute to architectural obstacles include, but are not limited to, antennas and filters. Unfortunately, these components also require large amounts of space within the communication device. Therefore, since antennas and filters require additional space, they place unwanted limitations on the size of communication devices.

### SUMMARY OF THE INVENTION

In light of the foregoing, the preferred embodiment of the present invention generally relates to a system and method for providing a multi-layered high density integrated wireless communication architecture.

Generally, to illustrate an example of use of the multi-layer, high density wireless communication architecture, a transceiver module is provided herein. The architecture utilized for the transceiver comprises a transmitting layer having a top portion and a bottom portion. A filter layer having a top portion and a bottom portion is also provided, wherein the top portion of the filter layer is adjacent to the bottom portion of the transmitting layer. A logic layer having a top portion and a bottom portion is provided, wherein the top portion is adjacent to the bottom portion of the filter layer and wherein logic is located on the bottom portion of the logic layer.

The present invention can also be viewed as a method for providing a high density integrated transceiver. In this regard, the method can be broadly summarized by the following steps: fabricating a transmitting layer having a top portion and a bottom portion; fabricating a filter layer below said bottom portion of said transmitting layer, wherein said filter layer comprises a top portion and a bottom portion, and wherein said top portion of said filter layer is adjacent to said bottom portion of said transmitting layer; and fabricating a logic layer below said bottom portion of said filter layer, wherein said logic layer comprises a top portion and a bottom portion, and wherein said top portion of said logic layer is adjacent to said bottom portion of said filter layer and wherein logic is situated on said bottom portion of said logic layer.

The invention has numerous advantages, a few of which are delineated here after as examples. Note that the embodiments of the invention, which are described herein, possess one or more, but not necessarily all, of the advantages set out hereafter.

One advantage of the invention is that it provides capability for decreasing the size of wireless communication devices without decreasing functionality.

Another advantage is that it allows antennas and filters to be included in wireless communication devices with minimal space requirements.

Other features and advantages of the present invention will become apparent to one with skill in the art upon examination of the following drawings and detailed description. It is intended that all such additional features and advantages be included herein within the scope of the present invention, as defined by the accompanying claims.

### BRIEF DESCRIPTION OF THE DRAWINGS

The present invention will be more fully understood from the detailed description given below and from the accompanying drawings of the preferred embodiments of the invention, which, however, should not be taken to limit the invention to the specific embodiments enumerated, but are for explanation and for better understanding only. Furthermore, the drawings are not necessarily to scale, emphasis instead being placed upon clearly illustrating the principles of the invention. Finally, like reference numerals in the figures designate corresponding parts throughout the several drawings.

FIG. 1 illustrates an environment in which a multi-layer, high density transceiver module may be implemented.

FIG. 2 illustrates a series of examples of wireless communication devices that may utilize the transceiver module of FIG. 1.

FIG. 3 further illustrates the transceiver module of FIG. 1.

FIG. 4 illustrates an alternative fabrication of the transceiver module of FIG. 3.

FIG. 5 is a cross-sectional view illustrating a possible way of connecting the transceiver module of FIG. 3 and a PCB.

### DETAILED DESCRIPTION OF THE PREFERRED EMBODIMENT

The present disclosure provides an example of multi-layer, high density transceiver module to demonstrate use of the present multi-layer, high density integrated wireless communication architecture. It should be noted that the present multi-layer density integrated wireless communication architecture may be used for other devices and modules besides transceiver modules. Examples of such devices and modules include, but are not limited to, cellular phones, wireless modems, wireless LAN modules, satellite transmit and receive assemblies, and automotive radars.

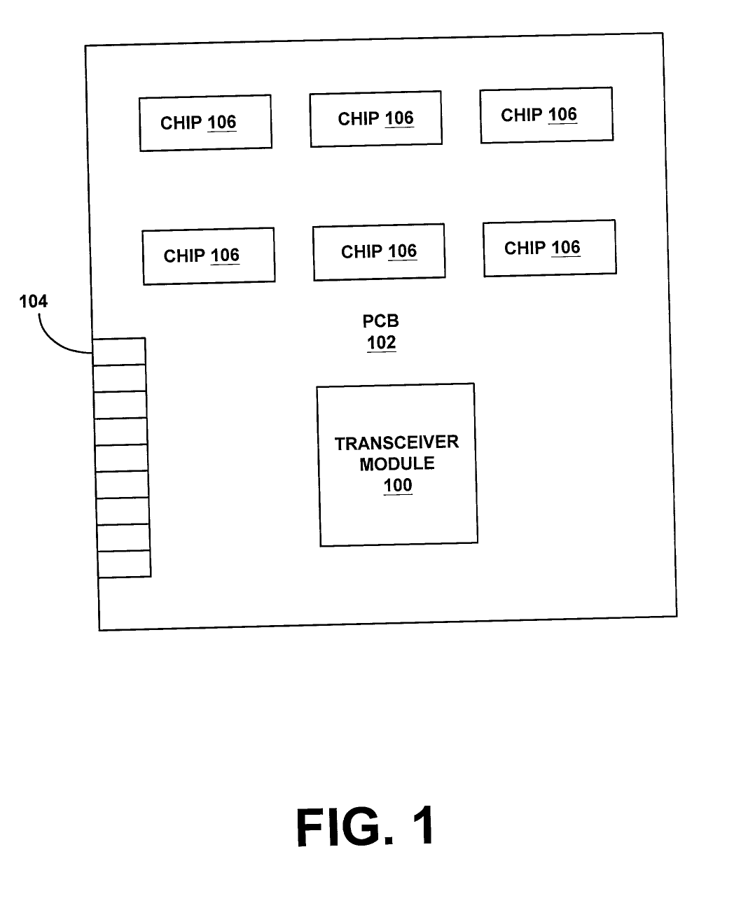

Turning now to the drawings, wherein like reference numerals designate corresponding parts throughout the drawings, FIG. 1 illustrates an environment in which the multi-layer, high density transceiver module 100 may be implemented. As shown by FIG. 1 a printed circuit board (PCB) 102 is utilized comprising functionality required by a wireless communication device. It should be noted that the present transceiver module 100 may instead be located on an application specific integrated circuit (ASIC).

The transceiver module 100 may be fabricated by using a low-temperature co-fired ceramic (LTCC) process, or any other fabrication process. LTCC is attractive for use in RF applications since low loss transmission line and high Q passives can be realized. Use of the LTCC process, and integration of an antenna (further discussed hereinbelow), preferably a cavity-backed patch antenna, provides an ultra compact and highly integrated transceiver module 100.

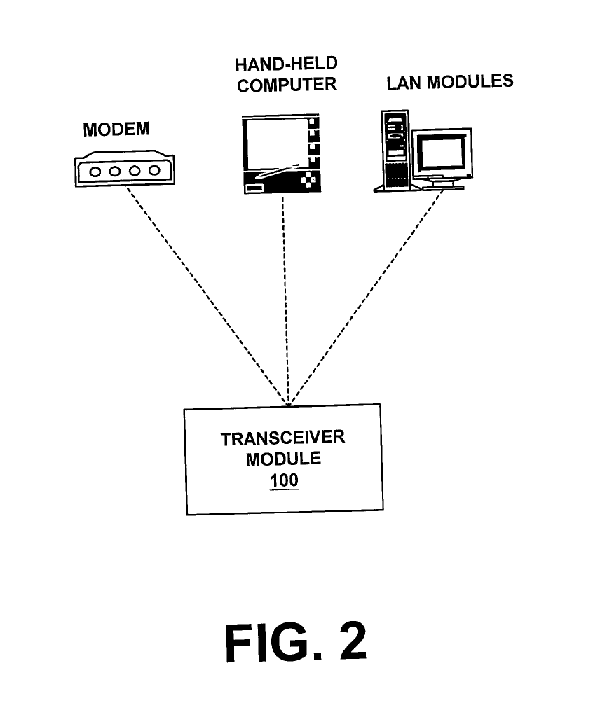

FIG. 2 provides a series of examples of wireless communication devices that may utilize the transceiver module 100. Examples of such devices include, but are not limited to, cellular phones, wireless modems, wireless LAN modules for hand-held computers, satellite transmit and receive assemblies, and automotive radars.

Returning to FIG. 1, the transceiver module 100 may be provided at any location of the PCB 102 in a manner similar to other chips and electronic components that may be located on the PCB 102. The PCB 102 preferably comprises an edge connector 104 for connecting the PCB into a wireless communication device. Also illustrated by FIG. 1 are multiple chips and electronic devices 106 that may be required by the transceiver module 100.

The transceiver module 100 of the present invention can be implemented in software, firmware, hardware, or a combination thereof. In the preferred embodiment of the invention, which is intended to be a non-limiting example, the transceiver module 100 is designed in software that is executed by a computer, for example, but not limited to, a personal computer, workstation, minicomputer, or mainframe computer, and then fabricated. Examples of software that may be used to design the transceiver module 100 include, but are not limited to, Agilent Advanced Design System, High-Frequency Structure Simulator (HFSS), Microwave Office, Sonnet Software, and IE3D.

The software used to design the transceiver module 100, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device.

The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

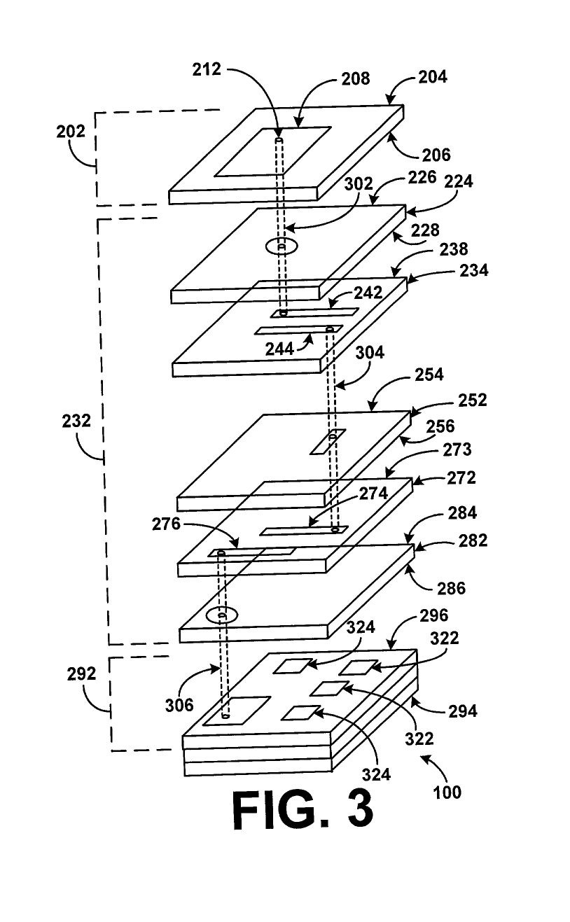

FIG. 3 further illustrates the transceiver module 100 of FIG. 1, in accordance with the preferred embodiment of the present invention. A key feature of the transceiver module 100 illustrated is the optimal use of vertical integration of various components which is described in detail herein below. The transceiver module 100 of FIG. 3 comprises an antenna portion 202, a pre-select filter portion 232, and a logic portion 292.

The antenna portion 202 of the transceiver module 100 comprises a top portion 204 and a bottom portion 206, wherein antenna logic 208 resides on the top portion 204. The top portion 204 of the antenna portion 202 resides as the top most portion of the transceiver module 100, thereby establishing a direct interface between the antenna logic 208 and air to assist in signal reception and transmission of the antenna logic 208. Preferably, the antenna logic 208 is fabricated in either a micro-strip patch or dielectric configuration. However, other configurations may also be substituted for fabrication of the antenna logic 208.

The antenna logic 208 may be fabricated upon the antenna portion 202 by utilizing a conductive material such as, but not limited to, gold or other metals with high conductivity such as copper and silver. Methods of placing the conductive material on the antenna portion 202 may include, but is not limited to, spinning, etching, sputtering, screen-printing, evaporating and micro-machining.

The antenna portion 202 also comprises an antenna portion via hole 212 that extends through the top and bottom portions 204, 206 of the antenna portion 202 and intersects the antenna logic 208. The antenna portion via hole 212 provides a vehicle for implementation of a first via structure 302 that provides a conductive connection between the antenna portion 202 and a first pre-select filter portion 234, through a first shielding layer 224. Via structures provided herein enable electrical communication throughout the transceiver module 100.

The first shielding layer 224 is located below the antenna portion 202 of the transceiver module 100 and comprises a top portion 226 and a bottom portion 228. The first shielding layer 224 prevents electronic coupling between the antenna portion 202 and the first pre-select filter portion 234. Preferably, the first shielding layer 224, as with all shielding layers provided herein, is fabricated of gold and/or other metals with high conductivity such as copper and silver. The shielding layers may be fabricated from other conductive materials as well. The first shielding layer 224 also comprises a via hole which extends through the top and bottom portions 226, 228 of the first shielding layer 224 for allowing implementation of the first via structure 302.

The first pre-select filter portion 234 is located beneath the first shielding layer 224. Preferably, a stripline topology is used to provide a pair of tracers on a top portion 238 of the first pre-select filter portion 234, wherein a first tracer 242 is an input to the first pre-select filter portion 234 and a second tracer 244 is an output from the first pre-select filter portion 234. The input 242 of the first pre-select filter portion 234 is electronically connected to the antenna logic 208 via the first via structure 302. The tracers may be fabricated by use of gold and/or other metals with high conductivity such as copper and silver.

A second shielding layer 252 is located below the first pre-select filter portion 234 and comprises a top portion 254 and a bottom portion 256. The second shielding layer 252 prevents electronic coupling between the first pre-select filter portion 234 and a second pre-select filter portion 272. The second shielding layer 252 also comprises a via hole which extends through the top and bottom portions 254, 256 of the second shielding layer 252 for allowing implementation of a second via structure 304.

The second pre-select filter portion 272 is located beneath the second shielding layer 252. Preferably, a stripline topology is used to provide a pair of tracers on a top portion 273 of the second pre-select filter portion 272, wherein a first tracer 274 is an input to the second pre-select filter portion 272 and a second tracer 276 is an output from the second pre-select filter portion 272. The input 274 of the second pre-select filter portion 272 is electronically coupled to the output 244 of the first pre-select filter portion 234 via the second via structure 304, wherein the second via structure 304 passes through the via hole located within the second shielding layer 252.

A third shielding layer 282 is located below the second pre-select filter portion 272 and comprises a top portion 284 and a bottom portion 286. The third shielding layer 282 prevents electronic coupling between the second pre-select filter portion 272 and the logic portion 292. The third shielding layer 282 also comprises a via hole which extends through the top and bottom portions 284, 286 of the third shielding layer 282 for allowing implementation of a third via structure 306. Therefore, the first, second and third shielding layers 224, 252, 282, in combination with the first and second pre-select filter portions 234, 272, make the pre-select filter portion 232. It should be noted that the pre-select filter portion 232 may have fewer or more pre-select filter portions and fewer, more, or no, shielding portions.

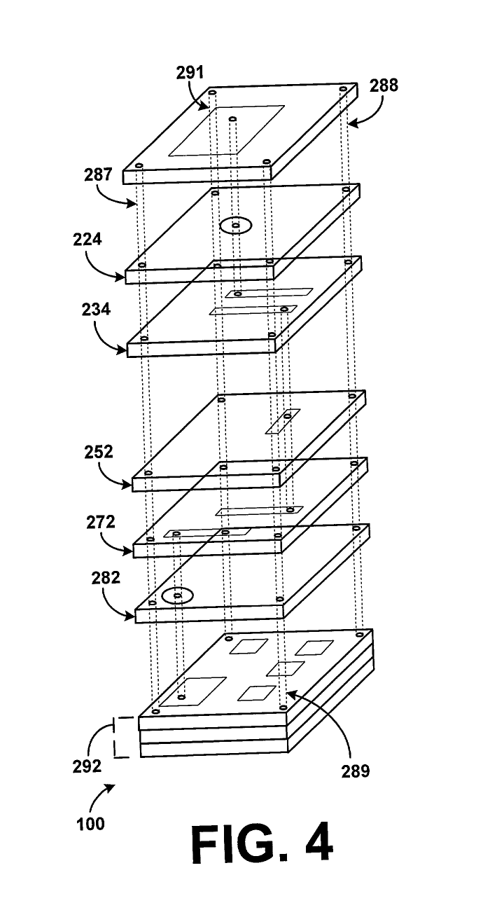

FIG. 4 is a diagram illustrating an alternative fabrication of the transceiver module 100 of FIG. 1. As shown by FIG. 4, four additional via structures 287, 288, 289, 291 are implemented for providing additional structural stability for the transceiver module 100. As such, one via structure extends through each corner of the first, second and third shielding layers 224, 252, 282, and the first and second pre-select filter portions 234, 272, and the logic portion 292. Of course, alternate structures may be implemented wherein fewer or more via structures are used.

Returning to FIG. 3, the logic portion 292 of the transceiver module 100 is located below the third shielding layer 282 and comprises a top portion 294 and a bottom portion 296. The bottom portion 296 of the logic portion 292 comprises chips and other components required to perform functionality required by the transceiver module 100. It should be noted that FIGS. 3 and 4 show the bottom portion 296 of the logic portion 292 facing upward for illustration purposes, however, as noted by the numbering of the top and bottom portions 294, 296, the bottom portion 296 of the logic portion 292 is intended to face downward and away from the pre-select filter portion 232. Preferably, monolithic microwave integrated circuit (MMIC) chips 322 and on-board integrated passive components 324 are located on the bottom portion 296 of the logic portion 292. For example, two MMIC attachments that may be used to connect to the MMIC chips 322 and on-board integrated passive components 324 to the logic portion 292 include the use of bond wires on chips 322 that are dropped in a cavity to ensure a short electrical path and minimize parasitics, and flip chip bumps. The logic portion 292 also comprises a via hole wherein the third via structure 306 is situated, thereby providing electrical connection between the second pre-select filter portion 272 and the logic portion 292.

The logic portion 292 is fabricated of a series of dielectric layers, three being illustrated by FIG. 3. It should be noted that additional, or fewer dielectric layers may be used to fabricate the logic portion 292. In addition, additional logic portions may be provided within the multi-layer, high density integrated communication architecture. In fact, the number of layers need only be limited by the device implemented by the multi-layer, high density architecture, which, in accordance with the present example, is a transceiver module 100.

The availability of additional dielectric layers makes possible the three dimensional deployment of other integrated passives such as, but not limited to, baluns, lumped inductors, capacitors, and resistors, as well as intermediate frequency (IF) or low pass filters, for example, in the case of a superheterodyne or direct conversion scheme, respectively. The integrated balun can be interfaced to a push-pull power amplifier or a mixer. The input matching of a low noise amplifier or input and output matching of a power amplifier, typically done by discrete passives, can be conveniently replaced by their on-board integrated version.

The LTCC process used offers screen printing and low loss stacked via processes as well as high conductivity metalization useful for high frequency applications. Various LTCC materials are presently available. Table 1 provided herein below provides a summary of a series of widely used LTCC and high temperatured co-fired ceramics (HTCC) materials and their respective properties supplied by manufacturers.

TABLE 1

| | | | Thermal | | | |
|---|---|---|---|---|---|---|
| | | | Conductivity | CTE | Tape | |
| | Dielectric | Loss | (W/m.K) at | (1/° C.) at | Thickness | |
| Material | Constant | Tangent | 293K | 25-200° C. | (mils) | Metal |
| HTCC | 9.6 | 0.0015 | 23 | 7.2 × 10⁻⁶ | 4-20 | Tungsten |
| | (1 MHz) | (1 MHz) | | | | |
| Dupont's | 7.8 | 0.0015 | 3 | 5.8 × 10⁻⁶ | 5-8.3 | Silver/Gold |
| 951 AT | (1 MHz) | (1 MHz) | | | | |
| Dupont's | 7.5 | 0.0015 | 3 | 5.3 × 10⁻⁶ | 5-8.3 | Silver/Gold |
| 943 AT | (1 MHZ) | (1 MHz) | | | | |
| Ferro A6- | 5.9 | <0.002 | 3 | 7 × 10⁻⁶ | 3.7-7.4 | Silver/Gold |
| M | (10 MHz) | (10 MHz) | | | | |

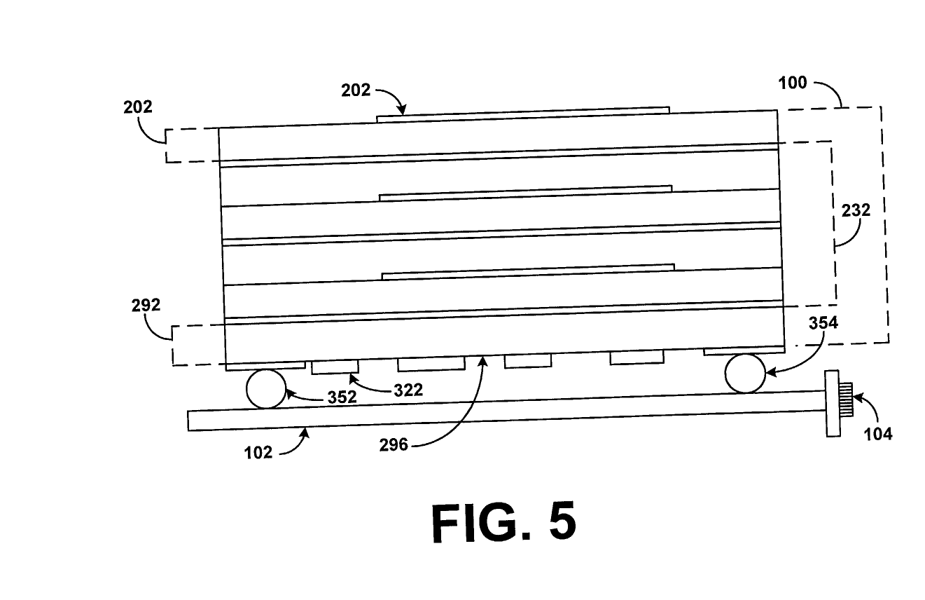

FIG. 5 is a cross-sectional view illustrating a possible way of connecting the transceiver module 100 and the PCB 102. The transceiver module 100 of FIG. 3 may be interfaced to the PCB 102 via ball-grid-array interconnects with the antenna 202 portion facing upward and the bottom portion 296 of the logic portion 292 facing downward. Referring to FIG. 5, a first ball grid interconnect 352 and a second ball grid array interconnect 354 connect the bottom portion 296 of the logic portion 292 to the PCB 102. Preferably, ball dimensions of about 30 mils or greater allow sufficient space between the attached MMIC chips 322 to the PCB 102 even when flip chip topology is chosen as the attachment option.

Therefore, use of the multi-layer, high density communication architecture replaces discrete elements typically incorporated in the conventional topology by integrating them on the PCB 102. It yields a considerably smaller module, which is extremely important for portable wireless electronic devices. The reduction in cost as a result of implementing the topology not only comes from the fact that the circuit module occupies smaller area, but also because it eliminates the needs for discrete elements and therefore, reduces the assembly time also. In addition, the reliability of a module implemented in this architecture also improves since solder joint failure is reduced due to the lack of use of discrete elements. Other elements may be located within the transceiver module 100 since they may be embedded inside the PCB 102. Such elements may include, but are not limited to, filters, additional antennas, inductors and capacitors. This would also be true if the multi-layer, high density communication architecture were used for a different module, besides the transceiver module 100 provided for herein.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. A system for providing a high density integrated transceiver, comprising:
an transmitting layer having a top portion and a bottom portion;
a filter layer having a top portion and a bottom portion, wherein said top portion of said filter layer is adjacent to said bottom portion of said transmitting layer; and
a logic layer having a top portion and a bottom portion, wherein said top portion is adjacent to said bottom portion of said filter layer and wherein logic is located on said bottom portion of said logic layer.

2. The system of claim 1, wherein said transmitting portion comprises an antenna that is fabricated from conductive material.

3. The system of claim 2, wherein said transmitting portion is located on a top most portion of said transceiver, such that said antenna establishes an interface to air.

4. The system of claim 1, further comprising a first shield layer that is located between said bottom portion of said transmitting layer and said top portion of said filter layer, wherein said first shield layer prevents electronic coupling from said transmitting layer to said filter layer.

5. The system of claim 4, further comprising a first via structure that electronically connects said transmitting layer to said filter layer through use of a transmitting layer via hole, a first filter layer via hole, and a first shield layer via hole, wherein said first via structure traverses from said transmitting layer via hole, through said first filter layer via hole, to said first shield layer via hole.

6. The system of claim 5, further comprising a second shield layer that is located between said bottom of said filter layer and said top of said logic layer, wherein said second shield layer prevents electronic coupling from said filter layer to said logic layer.

7. The system of claim 6, wherein said filter layer further comprises a first tracer and a second tracer located on said top portion of said filter layer, wherein said first tracer provides an input to said filter layer and said second tracer provides an output to said filter layer, and wherein said first filter layer via hole is located on said first tracer.

8. The system of claim 7, further comprising a second via structure that electronically connects said filter layer to said logic layer through use of a second filter layer via hole, located on said second tracer, a second shield layer via hole, and a logic layer via hole, wherein said second via structure traverses from said second filter layer via hole, through said second shield layer via hole, to said logic layer via hole.

9. The system of claim 1, wherein said logic layer comprises at least one dielectric layer.

10. The system of claim 1, wherein said logic comprises a series of monolithic microwave integrated circuit chips.

11. The system of claim 1, wherein said logic comprises a series of on-board integrated passive components.

12. The system of claim 1, wherein said transceiver is connected to a printed circuit board via at least one ball-grid array interconnect, wherein said interconnect is located on the bottom portion of the logic layer.

13. A method for providing a high density integrated transceiver, comprising the steps of:
fabricating a transmitting layer having a top portion and a bottom portion;
fabricating a filter layer below said bottom portion of said transmitting layer, wherein said filter layer comprises a top portion and a bottom portion, and wherein said top portion of said filter layer is adjacent to said bottom portion of said transmitting layer; and
fabricating a logic layer below said bottom portion of said filter layer, wherein said logic layer comprises a top portion and a bottom portion, wherein said top portion of said logic layer is adjacent to said bottom portion of said filter layer and wherein logic is situated on said bottom portion of said logic layer.

14. The method of claim 13, further comprising the step of fabricating an antenna on said top portion of said transmitting portion.

15. The method of claim 14, wherein said antenna is fabricated from conductive material.

16. The method of claim 13, further comprising the step of fabricating a first shield layer between said bottom portion of said transmitting layer and said top portion of said filter layer, wherein said first shield layer prevents electronic coupling from said transmitting layer to said filter layer.

17. The method of claim 16, further comprising the step of fabricating a first via structure to electronically connect said transmitting layer to said filter layer through use of a fabricated transmitting layer via hole, a fabricated first filter layer via hole, and a fabricated first shield layer via hole, wherein said first via structure traverses from said transmitting layer via hole, through said first filter layer via hole, to said first shield layer via hole.

18. The method of claim 17, further comprising the step of fabricating a second shield layer between said bottom of said filter layer and said top of said logic layer, wherein said second shield layer prevents electronic coupling from said filter layer to said logic layer.

19. The method of claim 18, further comprising the step of fabricating a first tracer and a second tracer on said top portion of said filter layer, wherein said first tracer provides an input to said filter layer and said second tracer provides an output to said filter layer, and wherein said first filter layer via hole has been fabricated on said first tracer.

20. The method of claim 19, further comprising the step of fabricating a second via structure to electronically connect said filter layer to said logic layer through use of a fabricated second filter layer via hole, that is fabricated on said second tracer, a fabricated second shield layer via hole, and a fabricated logic layer via hole, wherein said second via structure traverses from said second filter layer via hole, through said second shield layer via hole, to said logic layer via hole.

21. A system for providing a high density integrated transceiver, comprising:
means for transmitting and receiving a signal, having a top portion and a bottom portion;
means for filtering said signal located below said bottom portion of said means for transmitting, wherein said means for filtering comprises a top portion and a bottom portion, and wherein said top portion of said means for filtering is adjacent to said bottom portion of said means for transmitting; and
means for processing said signal located below said bottom portion of said means for filtering, wherein said means for processing comprises a top portion and a bottom portion, wherein said top portion of said means for processing is adjacent to said bottom portion of said means for filtering and wherein logic is situated on said bottom portion of said means for processing.

22. The system of claim 21, wherein said transmitting means includes an antenna.

23. The system of claim 22, wherein said antenna is fabricated from conductive material.

24. The system of claim 21, further comprising a first shield means located between said bottom portion of said transmitting means and said top portion of said filtering means, wherein said first shield means prevents electronic coupling from said transmitting means to said filtering means.

25. The system of claim 24, further comprising a means connecting said transmitting means to said filtering means.

26. The system of claim 25, further comprising a means a second means for shielding, wherein said second means for shielding prevents electronic coupling from said means for filtering to said processing means.

27. The system of claim 26, further comprising means for fabricating a first tracer and a second tracer on said top portion of said filter layer, wherein said first tracer provides an input to said filter layer and said second tracer provides an output to said filter layer, and wherein said first filter layer via hole has been fabricated on said first tracer.

28. The system of claim 27, further comprising means for fabricating a second via structure to electronically connect said filter layer to said logic layer through use of a second filter layer via hole, which is located on said second tracer, a second shield layer via hole, and a logic layer via hole, wherein said second via structure traverses from said second filter layer via hole, through said second shield layer via hole, to said logic layer via hole.
